(19) United States
(12) Patent Application Publication
(10) Pub. No.: US 2004/0118888 A1
(43) Pub. Date: Jun. 24, 2004

(54) Holder for helmet

(76) Inventor: Larry D. Russell, Bedford, TX (US)

Correspondence Address: Lynn E. Barber, Post Office Box 16528, Fort Worth, TX, 76162, US

(21) Appl. No.: 10/324,469

(22) Filed: Dec. 19, 2002

(51) Int. Cl. B62J 7/00; B62J 9/00; B62J 11/00; B60R 7/00; B60R 9/00; B60R 11/00

(52) U.S. Cl. 224/413; 224/427; 224/440; 224/463; 224/572

(57) ABSTRACT

A holder for a helmet including a seat strap that is attachable to a motorcycle seat; and a top piece having a central portion for placement over a motorcycle helmet. Two seat clips may be used to enable attachment of the seat strap to a motorcycle seat. Two tri-slides enable attachment of the top piece to the seat strap by means of top straps located on the sides of the central portion.

### BACKGROUND OF THE INVENTION

1. Field of the Invention

This invention relates generally to holders for articles, and in particular relates to a holder for a helmet on a motorcycle.

2. Description of the Related Art

Riders on motorcycles are required in many states to wear protective helmets. When a motorcycle rider is carrying an extra helmet for a passenger, or when a helmet is not required and is not being used, there is a need for a secure position on the motorcycle for the unused helmet. If the unused helmet is not attached firmly, there is a risk of losing the helmet or of damaging it when it is dangling and hitting the motorcycle or other objects while the motorcycle is in motion.

The prior devices designed to hold helmets on motorcycles are often complicated or difficult to use, do not provide a secure attachment of the helmet to the motorcycle, do not allow for attachment of various types of helmets, and/or are expensive to manufacture.

Prior devices include the BIKEMASTER stretch net, which can be hooked over pegs on sport bikes for use in holding helmets or other cargo distributed by Tucker Rocky Distributing, Fort Worth, Tex.

The strap assembly of McCay (U.S. Pat. No. 6,394,720) utilizes a flat shock cord section with a loop, and a flat webbing section, that may be affixed together with a side release buckle to be tightened.

The helmet holder of Schroeder (U.S. Pat. No. 5,884,825) uses a mounting block structure that has a helmet receiving slot in which the helmet is rotatably inserted. The mounting block structure is positioned over a body portion of the motorcycle, and is removably secured to the handlebar structure of the motorcycle.

The retaining device for a personal vehicle with handlebars of Wilson et al. (U.S. patent application Ser. No. 20020073751) comprises a retaining device with a cable, which fits within the handlebar when not in use, and when in use extends out of the distal end of the handlebar.

It is therefore an object of the invention to provide an inexpensive helmet holder for a motorcycle that enables secure attachment of the helmet to the motorcycle. It is a further object of the invention to provide a helmet holder that may be used to carry helmets of different shapes and sizes on the motorcycle.

Other objects and advantages will be more fully apparent from the following disclosure and appended claims.

### SUMMARY OF THE INVENTION

The invention herein is a holder for a helmet including a seat strap that is attachable to a motorcycle passenger seat; and a top piece having a central mesh portion for placement over a motorcycle helmet. Two seat clips may be used to attach the seat strap to a motorcycle seat, and two tri-slides enable attachment to the seat strap of the top piece when placed over the helmet, by means of hold-down straps attached to the sides of the central portion. Hook and loop fasteners are used to hold straps together.

Other objects and features of the inventions will be more fully apparent from the following disclosure and appended claims.

### BRIEF DESCRIPTION OF THE DRAWINGS

FIG. 1 is an elevational side view of the holder of the invention holding a helmet having a face shield on a motorcycle seat (remainder of motorcycle not shown) using tri-slides and seat clips.

FIG. 2 is a perspective side view of the holder of the invention holding a helmet on a motorcycle seat (remainder of motorcycle not shown) using tri-slides without seat clips.

FIG. 3 is a perspective side view of a seat clip of the invention.

FIG. 4 is a top plan view of a seat clip of the invention.

FIG. 5 is a perspective view of the underside thin edge of a motorcycle seat having a seat clip attached thereto.

FIG. 6 is a side perspective view of a portion of a motorcycle seat having a flat strap piece attached thereto by means of a seat clip of the invention.

FIG. 7 is a plan view of a tri-slide of the invention.

FIG. 8 is a cross-sectional view of a motorcycle seat having a lower thin side edge and the seat strap, clips and tri-slides of the first embodiment of the invention.

FIG. 9 is a cross-sectional view of a motorcycle seat and the seat strap and tri-slides of the second embodiment of the invention.

FIG. 10 is a top plan view of the top piece of the invention.

FIG. 11 is a top plan view of the top piece having an attached central stiffening means.

FIG. 12 is a perspective view of a safety clip attached to the strap mechanism.

FIG. 13 is a top plan view of an alternative top piece having outwardly protruding back and front edges.

### DETAILED DESCRIPTION OF THE INVENTION AND PREFERRED EMBODIMENTS THEREOF

The present invention is a helmet holder for use on the seats of motorcycles. As used herein the word “motorcycle” also includes motor scooters, as well as all types of motorcycles.

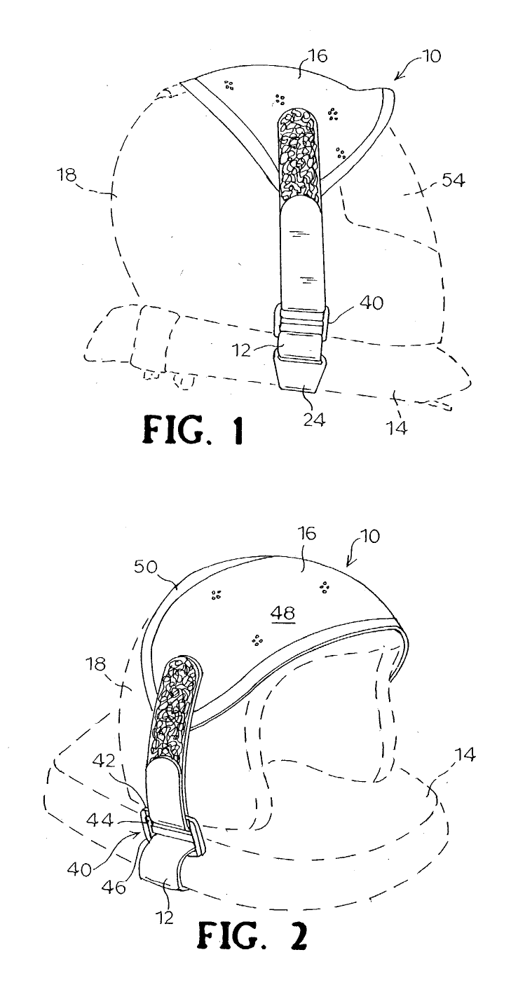

Referring to the figures, the helmet holder 10 of the invention comprises a flat seat strap 12 for fastening to, and extending over the top of, a motorcycle passenger seat 14 as is known in the art; and a top piece 16 for placement over a motorcycle helmet 18 (FIGS. 1-2). The top piece 16 is attachable to the seat strap 12 to hold the motorcycle helmet 18 firmly on the motorcycle seat 14.

For use with the majority of motorcycle seats 14 which have a lower thin side edge 20 on the sides of the seat 14, the first preferred embodiment comprises clips 24 holding a seat strap 12 to the seat (FIG. 1). In this embodiment, the seat strap 12 only needs to be as long as the distance between the sides of the seat 14 plus allowance for the seat strap 12 to be fastened around the two clips 24 and to extend across the top of the seat 14 (see below).

In a second preferred embodiment of the invention herein, a longer seat strap 12 is used to go around the entire seat 14, and clips 24 are not used (FIG. 2). Thus, the invention is useful even for other motorcycle seats 14 without such a lower thin edge 20.

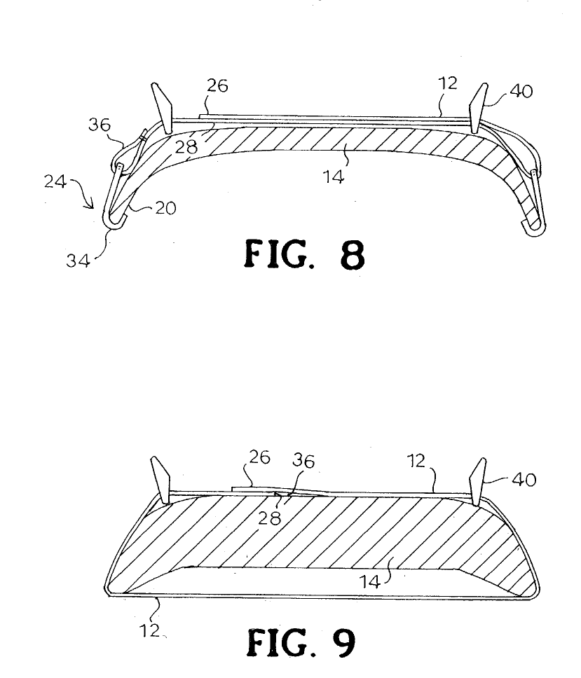

In both of these embodiments, the seat strap 12 has a first end 26 that is attachable to a mating portion 28 of the seat strap 12 by a hook and loop fastening means to cinch the seat strap 12 firmly to the motorcycle seat 14. In both embodiments, this mating portion 28 and first end 26 are preferably positioned on top of the seat when seat strap 12 is fastened together as shown in FIGS. 8-9. Preferably the seat strap 12 is made of WEBMATEΩ loop and ULTRAMATE™ hook (Velcro USA Inc., Manchester, N.H.).

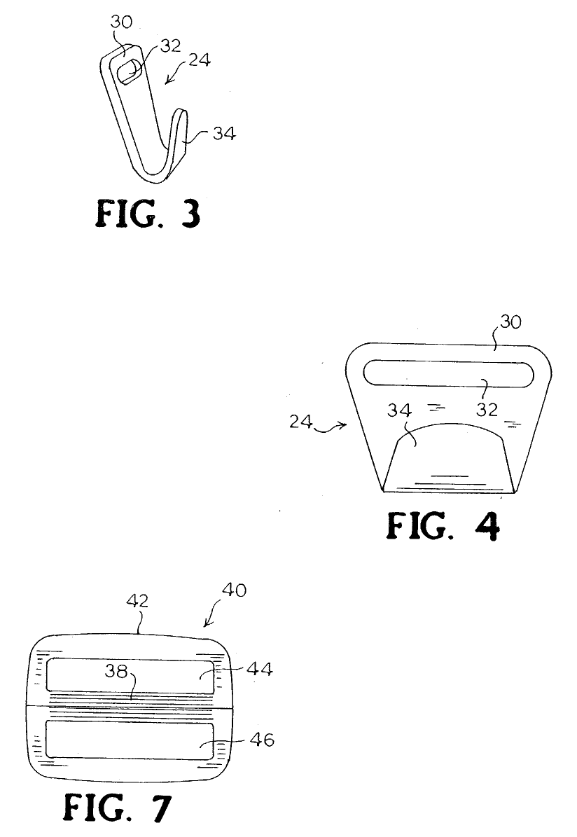

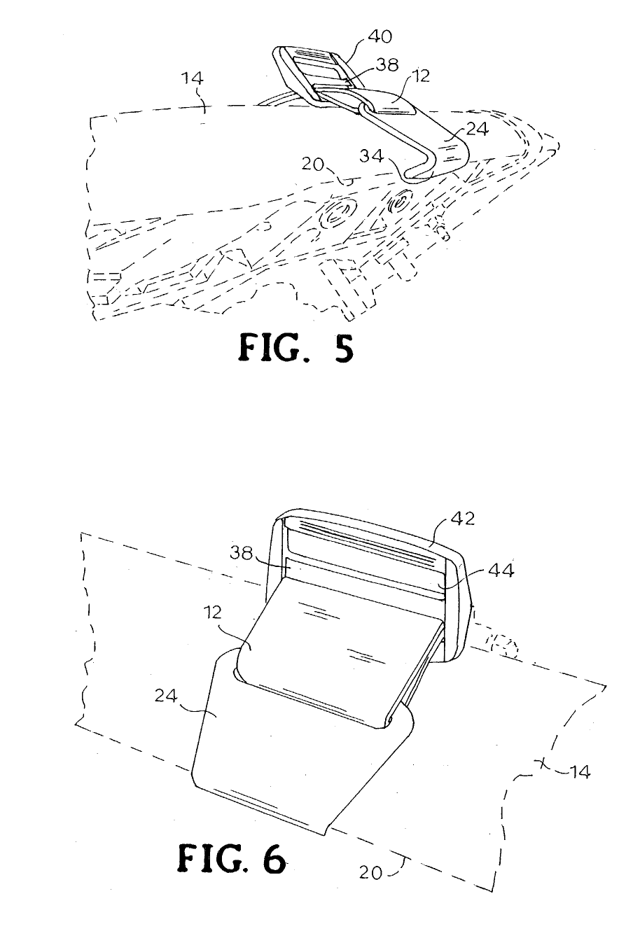

Each of the seat clips 24 in the first embodiment has an upper bar 30 (FIGS. 3-4) forming upper slot 32, through which slot 32 first end 26 of the seat strap fits, and a lower curved portion 34 for fitting under and around the lower thin side edge 20 on the sides of a motorcycle seat 14 (FIGS. 5-6). Although the lower curved portion 34 may have a variety of shapes, it is preferably bent in a smooth arc as shown, rather than a “v” shape to cradle the seat 14 safely without damage to the seat 14. To use the seat strap 12 of the first embodiment, the seat strap 12 has a second end 36 that is placed through the upper slot 30 of one of the seat clips 24 and preferably is permanently affixed thereto, for example, by sewing the second end 36 around the upper bar 32 of that seat clip 24 (FIG. 8). The seat strap 12 is then tightened on the motorcycle seat 14 by positioning the two seat clips 24 on opposite sides of the seat 14, with the lower curved portion 34 of each seat clip 24 firmly positioned under a lower thin side edge 20 of the motorcycle seat 14 (FIG. 8). The first end 26 of the seat strap 12 is placed through the upper slot 32 of the other seat clip 24, and is pulled to tighten the seat strap 12 between the seat clips 24. The hook and loop portion of the first end 26 of the seat strap 12 is placed against the mating portion 28 of the seat strap 12 to hold the seat strap 12 on the seat 14 between the seat clips 24.

To enable the top piece to be fastened to the strap, two tri-slides 40 (FIG. 7) are positioned on the seat strap 12 before the seat strap 12 is fastened on to the seat 14 and before inserting the seat strap 12 through the clips 24. Tri-slides that function well are Model AC201 (1.5 inches) sold by Velcro USA Inc. Each of the tri-slides 40 has an upper bar 42 forming a first elongated opening 44, and a second elongated opening 46 parallel to the first elongated opening 44. The preferred tri-slides 40 have a slight bend as shown in FIGS. 8-9, with the central bar 38 being offset so that one side of the tri-slide 40 is concave. In use the slightly concave side of the tri-slide 40 faces outward as shown in FIG. 5. The seat strap 12 is insertable through the second elongated opening 46 of each of the tri-slides 40 so that when the seat strap 12 is attached to a motorcycle seat 14, the tri-slides 40 are positionable at opposite sides of the top of the motorcycle seat 12 adjacent the clips 24 as shown (FIGS. 8-9).

In the second embodiment of the invention, the mating portion 28 on the seat strap is located adjacent to the second end 36 of the seat strap 12. Prior to placement of the seat strap 12 around the seat 14, two tri-slides 40 placed on to the seat strap 12 in the same manner as in the first embodiment, so that when the seat strap 12 is wrapped around the seat 14, the first end 26 of the seat strap 12 overlaps over the mating portion 28, preferably above the seat 14 and the tri-slides 40 are positioned at the upper sides of the seat (FIG. 9).

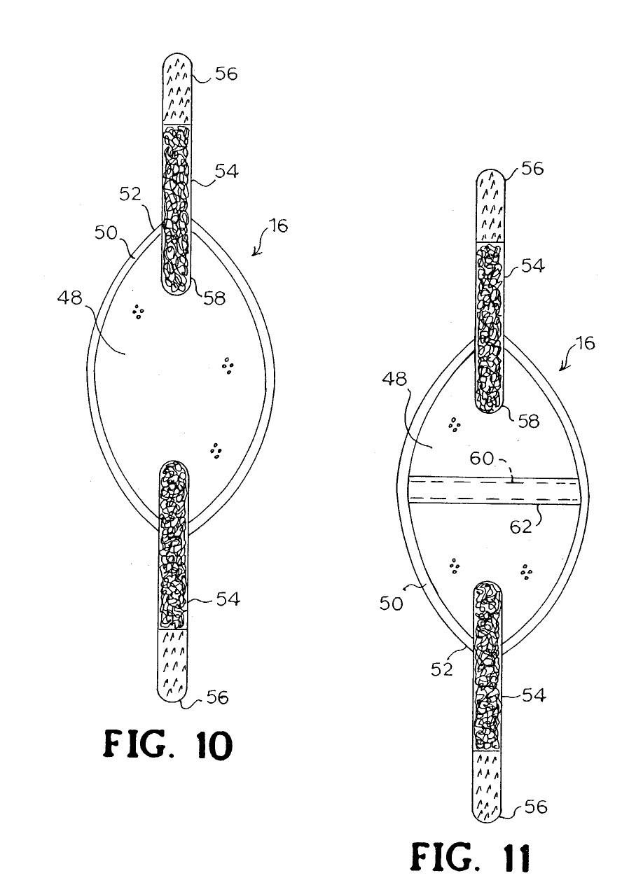

The top piece 16 of the invention comprises a central mesh portion 48 that is stretchable over a helmet 18. Preferably the central mesh portion 48 is made of a polyester mesh or other lightweight, flexible, stretchable material, which is preferably bound around its edges, for example, by polyester binding tape 50. Preferably the binding tape 50 is a 1-inch stretchable tape, folded in half lengthwise and sewn around the edges of the central mesh portion 48 as shown (FIG. 10). The general shape of the central portion 48 in a first embodiment is preferably an elongated oval that is gently tapered at its narrower ends as shown in FIGS. 10-11.

At each of the two tapered ends 52 of the top piece 16 is attached a hold-down strap 54, preferably attached to the top piece 16 by sewing. When the top piece 16 is in use, each hold-down strap 54 extends down from the tapered ends 52 of the top piece 16 on the sides of the helmet, and is placed through the first elongated opening 44 of the tri-slide 40 on that side of the motorcycle seat 14. Preferably, each hold-down strap 54 has at its free end 56 hook fastening means that are matable to an upper loop portion 58 of the hold-down strap 54 so that the end of the hold-down strap 54 may be firmly but releasably fixed to the upper portion 58 of the hold-down strap 54 to hold the helmet 18 firmly in place on the motorcycle seat 14.

To keep the central portion 48 of the top piece 16 from buckling or folding when in use, the helmet holder 10 preferably further comprises a central stiffening means 60 attached centrally on the central portion, extending between the back and front of the central portion 48 when the central portion 48 is in use (FIG. 11). The central stiffening means 60 needs to be stiff, but also flexible enough to bend at least slightly over the top of the helmet 18 when the top piece 16 is pulled tightly over the helmet 18. Preferably, the central stiffening means 60 is a plastic stay, for example, having dimensions of ½ inch×9 inches, and preferably it is encased in a webbing casing 62 and sewn to the central portion as shown so that the ends of the stiffening means 60 are covered by the tape 50. A 9-inch stay which serves this purpose is No. PP915 (Velcro USA Inc.).

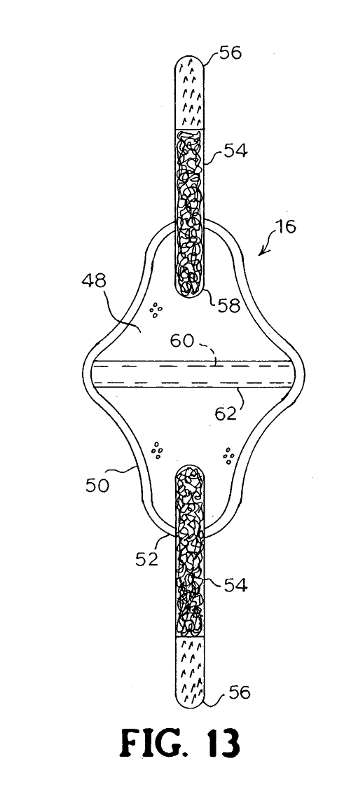

In a second preferred embodiment of the top piece 16 shown in FIG. 13, the front and back edges of the central mesh portion 48 protrude as shown in the figure in the area where the central stiffening means 60 meets tape 50, which is central along the edges between the two hold-down straps 54. This form allows a more snug fit of the top piece 16 on a helmet 18 when the helmet holder 10 is in use on a helmet 18. It is clear that other shapes of the central portion 48 may also be used in this invention with the other components of the invention, so long as the shape of the central portion 48 enables a helmet 18 to be held firmly on a motorcycle seat 14.

Preferably the seat strap 12 of the invention is made of WEB-MATE™ loop and ULTRAMATE™ hook fasteners (Velcro, Manchester, N.H.), as are the hold-down straps 54. Other fasteners, though not preferred, may alternatively be used so long as they provide a firm means of attachment and are easily fastened and unfastened.

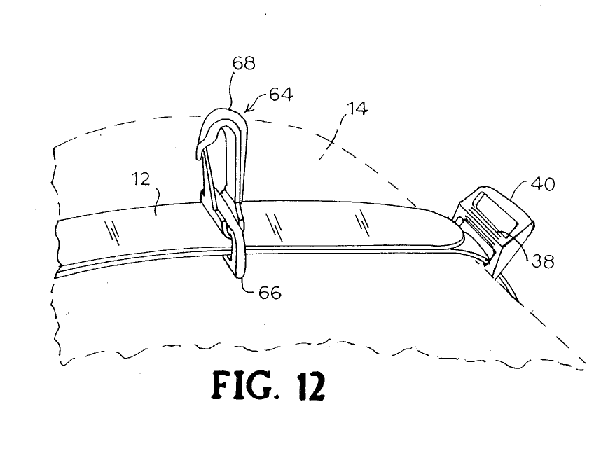

An additional option for use in the invention herein is a safety clip 64 attached at a first end 66 of the safety clip 64 to the seat strap, so that the safety clip 64 is centrally positionable along the seat strap 12 on the top of the seat 14 before the helmet 18 is placed on the seat 14 (FIG. 12). The openable end 68 of the safety clip 64, when attached to the helmet D-rings, or to other secure portion of the helmet (not shown), provides an additional safety mechanism to be sure that the helmet remains attached to the motorcycle seat 14. A suitable safety clip is a 1.5 inch swivel snap hook (AC103, Velcro USA Inc.).

While the invention has been described with reference to specific embodiments, it will be appreciated that numerous variations, modifications, and embodiments are possible, and accordingly, all such variations, modifications, and embodiments are to be regarded as being within the spirit and scope of the invention.

What is claimed is:

1. A helmet holder, comprising:
a) a seat strap for fastening to a motorcycle seat; and
b) a top piece for placement over a motorcycle helmet and attachable to said seat strap to hold the motorcycle helmet firmly on the motorcycle seat.

2. The helmet holder of claim 1, wherein the seat strap has a free end which is attachable to a mating hook and loop portion of the seat strap by hook and loop fastening means, to cinch the seat strap firmly to a motorcycle seat.

3. The helmet holder of claim 2, further comprising two seat clips, each of said seat clips comprising a) an upper bar; b) an upper slot formed by the upper bar and through which the seat strap is placed, and c) a lower curved portion for fitting under and around a lower edge of a motorcycle seat.

4. The helmet holder of claim 3, wherein the seat strap has a second end placed through the upper slot of one of the seat clips and permanently affixed thereto, and wherein the seat strap is tightened on the motorcycle seat by positioning the seat clips on opposite sides of the seat, with the lower curved portion of each seat clip under the lower edge of the motorcycle seat, placing the free end of the seat strap through the upper slot of a second one of said seat clips, pulling the seat strap tight between the seat clips, and fastening the free end of the seat strap to the mating hook and loop portion of the seat strap.

5. The helmet holder of claim 1, further comprising two tri-slides, each of said tri-slides having an upper bar, a first elongated opening, and a second elongated opening parallel to said first elongated opening, said seat strap being insertable through each of said first elongated openings so that when the seat strap is attached to a motorcycle seat, the tri-slides are positionable at opposite sides of the top of the motorcycle seat.

6. The helmet holder of claim 5, wherein the top piece has two sides, each of which sides is attachable to said seat strap by means of hold-down straps extending from the sides and being fastened through the second elongated opening of the tri-slide.

7. The helmet holder of claim 6, wherein each of the hold-down straps comprises an end having hook and loop fastening means that is matable to an upper portion of said hold-down strap.

8. The helmet holder of claim 6, wherein the top piece further comprises a central portion that is stretchable over a helmet.

9. The helmet holder of claim 8, wherein the central portion is made of a polyester mesh.

10. The helmet holder of claim 8, wherein the top piece further comprises a central stiffening means.

11. The helmet holder of claim 10, wherein the central stiffening means is a plastic stay.

12. The helmet holder of claim 1, wherein the seat strap is made of WEB-MATE™ loop and ULTRAMATE™ hook.

13. The helmet holder of claim 1, further comprising a safety clip attached at one end of the safety clip to the seat strap, so that it the safety clip is centrally positionable along the seat strap on the top of the seat, and is attachable at an openable end of the safety clip to a helmet.

14. A helmet holder, comprising:
a) a seat strap for fastening to a motorcycle seat having a free end which is attachable to a mating hook and loop portion of the seat strap by hook and loop fastening means, to cinch the seat strap firmly to a motorcycle seat;
b) two seat clips, each of said seat clips comprising a) an upper bar; b) an upper slot formed by the upper bar and through which the seat strap is placed, and c) a lower curved portion for fitting under and around a lower edge of a motorcycle seat;
c) two tri-slides, each of said tri-slides having an upper bar, a first elongated opening, and a second elongated opening parallel to said first elongated opening, said seat strap being insertable through each of said first elongated openings so that when the seat strap is attached to a motorcycle seat, the tri-slides are positionable at opposite sides of the top of the motorcycle seat; and
d) a top piece for placement over a motorcycle helmet and attachable to said tri-slides to hold the motorcycle helmet firmly on the motorcycle seat, said top piece having two sides, each of which sides is attachable to said seat strap by means of hold-down straps extending from the sides and being fastened through the second elongated opening of the tri-slide.

15. The helmet holder of claim 14, wherein the seat strap has a second end placed through the upper slot of one of the seat clips and permanently affixed thereto, and wherein the seat strap is tightened on the motorcycle seat by positioning the seat clips on opposite sides of the seat, with the lower curved portion of each seat clip under the lower edge of the motorcycle seat, placing the free end of the seat strap through the upper slot of a second one of said seat clips, pulling the seat strap tight between the seat clips, and fastening the free end of the seat strap to the mating hook and loop portion of the seat strap.

16. The helmet holder of claim 14, wherein each of the hold-down straps comprises an end having hook and loop fastening means that is matable to an upper portion of said hold-down strap.

17. The helmet holder of claim 14, wherein the top piece further comprises a central portion that is stretchable over a helmet.

18. The helmet holder of claim 17, further comprising a safety clip attached at one end of the safety clip to the seat strap, so that it the safety clip is centrally positionable along the seat strap on the top of the seat, and is attachable at an openable end of the safety clip to a helmet.

19. A helmet holder, comprising:
a) a seat strap for fastening to a motorcycle seat, said seat strap being long enough to extend around the motorcycle seat and having a first end attachable to a mating hook and loop portion of said seat strap;
b) two tri-slides, each of said tri-slides having an upper bar, a first elongated opening, and a second elongated opening parallel to said first elongated opening, said seat strap being insertable through each of said first elongated openings so that when the seat strap is attached to a motorcycle seat, the tri-slides are positionable at opposite sides of the top of the motorcycle seat; and
c) a top piece for placement over a motorcycle helmet and attachable to said tri-slides to hold the motorcycle helmet firmly on the motorcycle seat, said top piece having two sides, each of which sides is attachable to said seat strap by means of hold-down straps extending from the sides and being fastened through the second elongated opening of the tri-slide.

20. The helmet holder of claim 19, further comprising a safety clip attached at one end of the safety clip to the seat strap, so that it the safety clip is centrally positionable along the seat strap on the top of the seat, and is attachable at an openable end of the safety clip to a helmet.
